(19) United States
(12) Patent Application Publication
(10) Pub. No.: US 2026/0301470 A1
(43) Pub. Date: Oct. 1, 2026

(54) DETECTING A FACIAL AUTHENTICATION ATTACK

(71) Applicant: Lenovo (United States) Inc., Morrisville, NC (US)

(72) Inventors: Sean C. Kelly, Wake Forest, NC (US); Koji Kawakita, Yokohama (JP); Yasushi Tsukamoto, Yokohama (JP)

(21) Appl. No.: 19/096,493

(22) Filed: Mar. 31, 2025

(51) Int. Cl. G06V 40/40; G06F 21/32; G06T 7/00

(52) U.S. Cl. CPC G06V 40/40; G06F 21/32; G06T 7/0002

(57) ABSTRACT

A method for detecting an attack on a facial authentication system is disclosed. The method includes capturing, by an IR camera, a first set of images when an IR illuminator is turned on and a second set of images when the IR illuminator is turned off. The method includes determining a set of exposure difference values between the first set of images and the second set of images and identifying an attack in response to the set of exposure difference values satisfying a first threshold.

### FIELD

The subject matter disclosed herein relates to facial authentication and more particularly relates to detecting an attack on a facial authentication system.

### BACKGROUND

Facial authentication is a biometric authentication method that uses facial recognition technology to verify a person's identity. Upon successful authentication, the device may be unlocked, therefore the term “face unlock” as used herein refers to a facial authentication technique for permitting an authorized user to access a resource, such as a device or system.

Face unlock is generally used to unlock a phone, laptop, tablet personal computer (“PC”), and/or other electronic device. Face unlock can also be used to sign in to applications or to confirm payments. However, the face unlock may be defeated with an inexpensive, infrared (“IR”) display system that simulates the imaging physics of imaging a real face with an IR sensor under 850nm IR illumination. An attack vector may be constructed by removing a liquid-crystal display’s (“LCD”) white backlight and replacing it with an array of 850nm light emitting diodes (“LEDs”) and a diffusor. The LCD may then spatially modulate the 850nm backlight with an LCD video image of the owner’s face. The image created may appear as if the user was in front of his device engaging face unlock. This may result in ability to unlock the device that uses face unlock feature.

### BRIEF SUMMARY

A method for detecting an attack on a facial authentication system is disclosed. An apparatus and a program product also perform the functions of the method. The method includes capturing, by an IR camera, a first set of images when an IR illuminator is turned on and a second set of images when the IR illuminator is turned off. The method includes determining a set of exposure difference values between the first set of images and the second set of images and identifying an attack in response to the set of exposure difference values satisfying a first threshold.

According to another aspect of the preset disclosure, an apparatus for detecting an attack on a facial authentication system is disclosed. The apparatus may include a processor and non-transitory computer readable storage media storing code. The code may be executable by the processor to perform operations that include capturing, by an IR camera, a first set of images when an IR illuminator is turned on and a second set of images when the IR illuminator is turned off. The operations include determining a set of exposure difference values between the first set of images and the second set of images and identifying an attack in response to the set of exposure difference values satisfying a first threshold.

According to another aspect of the present disclosure, a program product for detecting an attack on a facial authentication system is disclosed. The program product may include a non-transitory computer readable storage medium storing code. The code may be configured to be executable by a processor to perform operations that include capturing, by an infrared (“IR”) camera, a first set of images when an IR illuminator is turned on and a second set of images when the IR illuminator is turned off. The operations include determining a set of exposure difference values between the first set of images and the second set of images and identifying an attack in response to the set of exposure difference values satisfying a first threshold.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system for detecting an attack on a facial authentication system, in accordance with aspects of the present disclosure.

FIG. 2 is a schematic block diagram illustrating an apparatus for detecting an attack on a facial authentication system, in accordance with aspects of the present disclosure.

FIG. 3 is a schematic block diagram illustrating another apparatus for detecting an attack on a facial authentication system, in accordance with aspects of the present disclosure.

FIG. 4 is a timing diagram illustrating duty cycle of an IR illuminator and an IR camera, in accordance with aspects of the present disclosure.

FIG. 5 is a schematic block diagram illustrating a user device under an attack, in accordance with aspects of the present disclosure.

FIG. 6A is a block diagram illustrating the use of a polarizer, in accordance with aspects of the present disclosure.

FIG. 6B is a block diagram illustrating rotation of the polarizer, in accordance with aspects of the present disclosure.

FIG. 7 is a schematic flow chart diagram illustrating a method for detecting an attack on a facial authentication system, in accordance with aspects of the present disclosure.

FIG. 8 is a schematic flow chart diagram illustrating another method for detecting an attack on a facial authentication system, in accordance with aspects of the present disclosure.

FIG. 9 is a schematic flow chart diagram illustrating another method for detecting an attack on a facial authentication system, in accordance with aspects of the present disclosure.

FIG. 10 is a schematic flow chart diagram illustrating another method for detecting an attack on a facial authentication system, in accordance with aspects of the present disclosure.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the "C" programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products in accordance with aspects of the present disclosure. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

A method for detecting an attack on a facial authentication system is disclosed. An apparatus and a program product also perform the functions of the method. The method includes capturing, by an infrared (“IR”) camera, a first set of images when an IR illuminator is turned on and a second set of images when the IR illuminator is turned off. The method includes determining a set of exposure difference values between the first set of images and the second set of images and identifying an attack in response to the set of exposure difference values satisfying a first threshold.

In some embodiments the method includes performing a face authentication, performing the face authentication is limited to a period when the IR illuminator is turned on. In some embodiments, the method includes performing the face authentication in response to the set of exposure difference values not satisfying the first threshold. In some embodiments, the method includes varying a duty cycle of the IR camera and the IR illuminator.

In some embodiments, the method includes searching the first set of images for an illumination hotspot or a retro-reflection, or both and identifying the attack in response to detecting the illumination hotspot or the retro-reflection, or both. In some embodiments, the method includes adjusting a polarization associated with inbound IR light captured at the IR camera. In some embodiments, the method includes determining a first exposure value of a first image associated with a first polarization and determining a second exposure value of a second image associated with a second polarization. In some embodiments, the method includes identifying the attack in response to a difference between the first exposure value and the second exposure value satisfying a second threshold. In some embodiments, the method includes alerting a user in response to identifying the attack.

According to another aspect of the preset disclosure, an apparatus for detecting an attack on a facial authentication system is disclosed. The apparatus may include a processor and non-transitory computer readable storage media storing code. The code may be executable by the processor to perform operations that include capturing, by an IR camera, a first set of images when an IR illuminator is turned on and a second set of images when the IR illuminator is turned off. The operations include determining a set of exposure difference values between the first set of images and the second set of images and identifying an attack in response to the set of exposure difference values satisfying a first threshold.

In some embodiments the operations include performing a face authentication, performing the face authentication is limited to a period when the IR illuminator is turned on. In some embodiments, the operations include performing the face authentication in response to the set of exposure difference values not satisfying the first threshold. In some embodiments, the operations include varying a duty cycle of the IR camera and the IR illuminator.

In some embodiments, the operations include searching the first set of images for an illumination hotspot or a retro-reflection, or both and identifying the attack in response to detecting the illumination hotspot or the retro-reflection, or both. In some embodiments, the operations include adjusting a polarization associated with inbound IR light captured at the IR camera. In some embodiments, the operations include determining a first exposure value of a first image associated with a first polarization and determining a second exposure value of a second image associated with a second polarization. In some embodiments, the operations include identifying the attack in response to a difference between the first exposure value and the second exposure value satisfying a second threshold. In some embodiments, the operations include alerting a user in response to identifying the attack.

According to another aspect of the present disclosure, a program product for detecting an attack on a facial authentication system is disclosed. The program product may include a non-transitory computer readable storage medium storing code. The code may be configured to be executable by a processor to perform operations that include capturing, by an IR camera, a first set of images when an IR illuminator is turned on and a second set of images when the IR illuminator is turned off. The operations include determining a set of exposure difference values between the first set of images and the second set of images and identifying an attack in response to the set of exposure difference values satisfying a first threshold.

In some embodiments the operations include performing a face authentication, performing the face authentication is limited to a period when the IR illuminator is turned on. In some embodiments, the operations include performing the face authentication in response to the set of exposure difference values not satisfying the first threshold. In some embodiments, the operations include varying a duty cycle of the IR camera and the IR illuminator.

In some embodiments, the operations include searching the first set of images for an illumination hotspot or a retro-reflection, or both and identifying the attack in response to detecting the illumination hotspot or the retro-reflection, or both. In some embodiments, the operations include adjusting a polarization associated with inbound IR light captured at the IR camera. In some embodiments, the operations include determining a first exposure value of a first image associated with a first polarization and determining a second exposure value of a second image associated with a second polarization. In some embodiments, the operations include identifying the attack in response to a difference between the first exposure value and the second exposure value satisfying a second threshold. In some embodiments, the operations include alerting a user in response to identifying the attack.

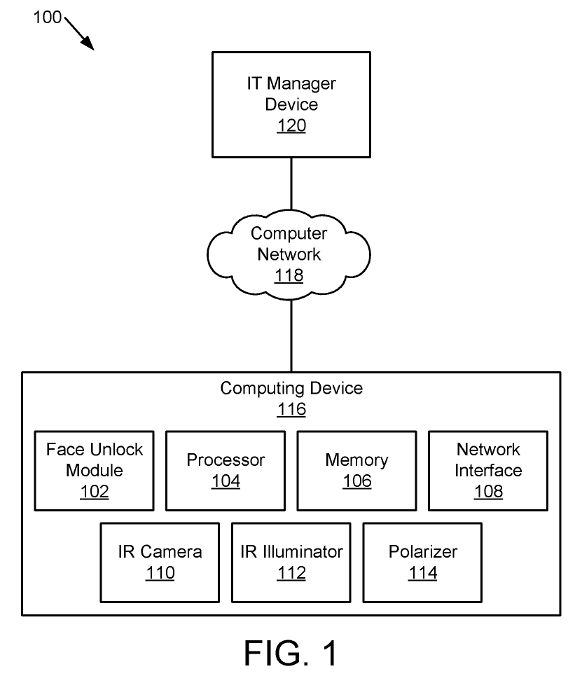

FIG. 1 is a schematic block diagram illustrating a system 100 for detecting an attack on a facial authentication system, in accordance with aspects of the present disclosure. The system 100 includes a face unlock module 102, a processor 104, a memory 106, a network interface 108, an IR camera 110, an IR illuminator 112, a polarizer 114, a computing device 116, a computer network 118, and an information technology (“IT”) manager device 120.

Face unlock or face authentication is a biometric authentication method that uses facial recognition technology to verify a person's identity. Face unlock systems using IR cameras and IR illuminators work by projecting IR light onto the user's face, allowing the IR camera to capture detailed facial features even in low-light or no-light conditions. The captured IR data may be processed using artificial intelligence (“AI”) and machine learning, comparing them with a stored facial template for authentication.

Face unlock is generally used to unlock a phone, laptop, tablet PC, and/or other electronic device. It can also be used to sign in to applications (also referred to as “apps”) or confirm payments. For example, Windows Hello, Apple Face ID, Google Face Unlock, etc. However, conventional face unlock systems may be defeated by IR image spoofing with a relatively inexpensive, IR display system that simulates the imaging physics of imaging a real face with an IR sensor under IR illumination (e.g., using 850 nm IR illumination).

In some examples, an attack vector may be constructed from a commercially available LCD system by removing the LCD’s white backlight and replacing it with an array of IR-wavelength LEDs and a diffusor. For example, IR LEDs that emit light at 850 nm are commercially available and relatively inexpensive. Moreover, 850nm IR cameras are often used in conventional face unlock system. The liquid crystal layer spatially modulates the IR backlight, thereby blocking or transmitting varying amounts of IR light, creating a structured IR image similar to how an original human face would appear under IR illumination. When viewed by an IR-sensitive camera (e.g. IR camera), the modulated IR backlight can mimic an expected facial pattern, potentially fooling the authentication system into granting access to the attacker. In some examples, the image created may appear as if the user was in front of the user device engaging face unlock. This may result in the ability to unlock the device that is secured by face unlock.

The face unlock module 102 enables a user device (e.g., computing device 116) to determine if a face is real or synthesized by an attack system (e.g., IR LCD attack system). The face unlock module 102 also enables the user device to identify the attack and alert the user of the user device or an information technology IT manager.

In some embodiments, the face unlock module 102 captures, by an IR camera 110, a first set of images when an IR illuminator 112 is turned on and a second set of images when the IR illuminator 112 is turned off. In some embodiments, the face unlock module 102 determines a set of exposure difference values between the first set of images and the second set of images. In some embodiments, the face unlock module 102 determines an exposure difference value between an average exposure value of the first set of images and an average exposure value of the second set of images. In some embodiments, the face unlock module 102 determines an exposure value between the highest exposure difference value of the first set of images and the highest exposure value of the second set of images. In some embodiments, the face unlock module 102 determines an exposure difference value between the lowest exposure value of the first set of images and the lowest exposure value of the second set of images.

In some embodiments, the face unlock module 102 may calculate the differences between the one or more exposure values of the first set of images and the one or more exposure values of the second set of images to determine the set of exposure difference values between the first set of images and the second set of images. In some embodiments, the exposure of the first set of images and the second set of images is measured based on the amount of IR radiation detected over a period at the IR camera 110.

In some embodiments, the face unlock module 102 identifies an attack in response to the set of exposure difference values satisfying a first threshold. In some examples, the attack includes attacker spoofing an IR image of the user to unlock the user’s device (e.g., computing device 116). In some examples, the attack refers to an attempt to access a device or resource without the authorized user being physically present in front of the IR camera 110. In some examples, the set of exposure difference values may satisfy a first threshold in response to any of the calculated exposure difference values being greater than the first threshold. In some embodiments, the face unlock module 102 performs the face authentication in response to the set of exposure difference values not satisfying the first threshold. In some embodiments, the set of exposure difference values may not satisfy a first threshold in response to all of the calculated exposure difference values being less than the first threshold.

In some embodiments, the first threshold is a predefined exposure value. In certain implementations, the first threshold may be defined as a predetermined percentage of the maximum exposure value associated with the first set of images (i.e., those captured when the IR illuminator 112 is turned on). For example, the first threshold may be set as 10% of the maximum exposure value. In this scenario, if the exposure values associated with the set of second images is not at least 90% less than the maximum exposure value (i.e. as indicated by the set of exposure difference values), then the amount of IR light captured with the second set of images is indicative of an IR attack system emitting IR light and attempting to spoof the facial features of an authorized user; therefore, the face unlock module 102 identifies that an attack is occurring. However, in other implementations, the first threshold may be set as greater than (or less than) 10% of the maximum exposure value. In general, the value of the first threshold will depend upon specific parameters, like the polarizer extinction ratio, and may vary based on specific implementation them individual implementation. In certain embodiments, the first threshold may be adjustable by an administrator or other authorized user. In certain embodiments, the specific value of the first threshold may vary based on certain factors, such as manufacturer or model of the system or device implementing the face unlock module 102, the location of the system or device implementing the face unlock module 102, the time of day, etc.

In some embodiments, the face unlock module 102 performs a face authentication. In some embodiments, performing the face authentication is limited to a period when the IR illuminator 112 is turned on. In some embodiments, the face unlock module 102 performs face authentication using the first set of images that were captured when the IR illuminator 112 was on.

In some embodiments, the face unlock module 102 varies the duty cycle of the IR camera 110 and/or the duty cycle of the IR illuminator 112. In certain embodiments, the duty cycle of the IR camera 110 may be different from the duty cycle of the IR illuminator 112. As used herein, the term “duty cycle” refers to the percentage of time a device is actively on compared to the time the device is off within a given period. It should be noted that varying the duty cycle is different from pulse width modulation (PWM). Varying the duty cycle for devices like IR camera 110 and IR illuminator 112 adjusts timing, while PWM specifically controls power by varying the width of pulses in a consistent cycle. PWM is often used to regulate brightness or motor speed. Moreover, the duration of the duty cycle is generally much longer than the PWM cycle.

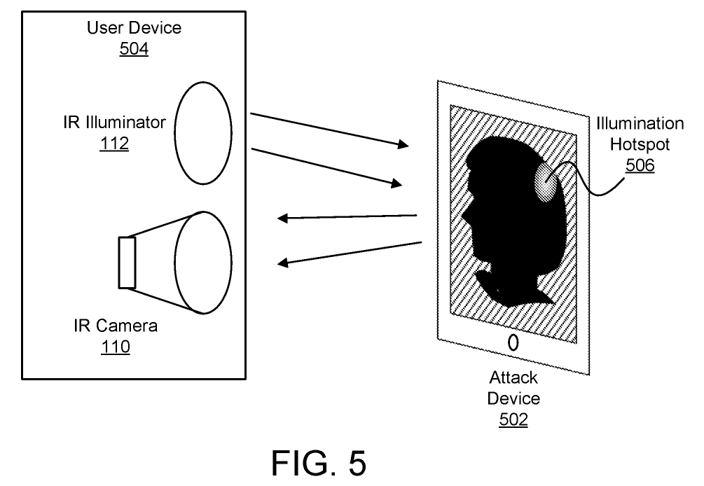

In some embodiments, the face unlock module 102 searches the first set of images for an illumination hotspot or a retro-reflection, or both. In some examples, the face unlock module 102 may identify a specular reflection from an attack device, as described in greater detail with reference to FIG. 5. In some embodiments, illumination hotspot may refer to an uneven brightness on the screen where certain areas appear much brighter than others. In some embodiments, the retro-reflection may refer to light reflecting to its source with minimal scattering. In some embodiments, the face unlock module 102 identifies the attack in response to detecting the illumination hotspot or the retro-reflection, or both. In some embodiments, detecting the illumination hotspot or the retro-reflection may be an independent technique for identifying an attack. In other embodiments, detecting the illumination hotspot or the retro-reflection may be a technique that is used in conjunction with the technique of identifying an attack in response to the set of exposure difference values satisfying a first threshold.

In some embodiments, the face unlock module 102 adjusts a polarization associated with inbound IR light captured at the IR camera 110. In some embodiments, adjusting the polarization includes adjusting the polarizer 114 to rotate the polarization angle of the inbound IR light, the polarizer 114 placed in front of the IR camera 110. In one embodiment, the polarizer 114 is implemented by a polarizing filter that can be rotated with respect to the IR camera 110. In another embodiment, the polarizer 114 is implemented by a liquid crystal layer in front of the IR camera 110, where an electric field applied to the liquid crystal layer may be varied to change the alignment of the liquid crystal molecules. In general, inbound IR light refers to the IR light that is being received or detected by a sensor (e.g., IR camera 110).

In some embodiments, the face unlock module 102 determines a first exposure value of a first image associated with a first polarization. In some embodiments, the first exposure value is the amount of IR radiation detected over a period of time at the IR camera before adjusting the polarization. In some embodiments, the face unlock module 102 determines a second exposure value of a second image associated with a second polarization, different than the first polarization. In some embodiments, the second exposure value is the amount of IR radiation detected over another period of time at the IR camera after adjusting the polarization. In some embodiments, the face unlock module 102 identifies the attack in response to a difference between the first exposure value and the second exposure value satisfying a second threshold. In some embodiments, the second threshold is a predefined value different from the first threshold. In some embodiments, the second threshold is associated with adjusting the polarization.

In some embodiments, the face unlock module 102 alerts a user in response to identifying the attack. In some embodiments, alerting a user may include sending a notification to another user device (e.g., smartphone) of the user that the first user device (e.g., computing device 116) is under attack. In some embodiments, alerting a user may include sending a notification to an IT manager that the computing device 116 is under attack.

The system 100 includes a computing device 116 that includes the face unlock module 102, at least one processor 104 to perform operations, the memory 106, the network interface 108, the IR camera 110, the IR illuminator 112, and the polarizer 114. The computing device 116 may further include, in general, a non-volatile memory, communication buses, etc. In some embodiments, the computing device 116 may refer to a user device that uses face unlock to verify the user’s identity. In some embodiments, the computing device 116 may be, for example, a smartphone, a laptop, a desktop computer, a tablet PC, etc. In some embodiments, the network interface 108 may refer to a hardware component or software that allows a computer to connect to a network. In some embodiments, the network interface 108 may refer to a network interface card (NIC), a network adapter, or a network interface controller.

In some embodiments, the IR camera 110 may refer to a camera device that captures images using IR radiation emitted and/or reflected by objects. In some embodiments, the IR illuminator 112 may refer to a device that emits IR light, which is invisible to the human eye, but can be detected by specialized cameras or sensors, allowing for visibility in low-light or complete darkness. In some embodiments, the IR illuminator 112 may emit light at an IR wavelength of 850nm or 940nm. In some examples, the IR illuminator 112 may emit at another wavelength which may be used for face unlock in the future. In some embodiments, the polarizer 114 may refer to an optical filter that lets light waves of a specific polarization pass through while blocking light waves of other polarizations.

The system 100 may include an IT manager device 120 that is used by an IT manager to receive alerts from the computing device 116 when the computing device 116 is under attack. The IT manager device 120 may be for example, an electronic device such as a smart phone, a laptop, a desktop computer or the like. The IT manager may then take new actions, based on the received alert, to protect the computing device 116 from being exposed to the attacker.

The system 100 may include a computer network 118 that is used by the computing device 116 to connect with the IT manager device 120. The computer network 118, in some embodiments, includes a LAN, a WAN, a fiber network, a wireless connection, the Internet, or the like. In some embodiments, the computer network 118 includes two or more networks. In some embodiments, the computer network 118 includes servers, wiring, switches, routers, etc.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

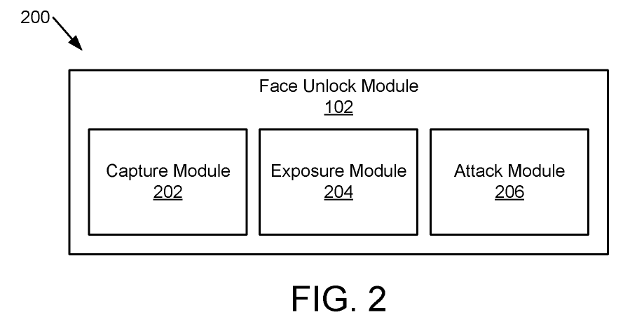

FIG. 2 is a schematic block diagram illustrating an apparatus 200 for detecting an attack on a facial authentication system, in accordance with aspects of the present disclosure. The apparatus 200 includes a face unlock module 102 that includes a capture module 202, an exposure module 204, and an attack module 206. In some embodiments, the apparatus 200 is implemented using executable code stored on a computer readable storage device, which is non-transitory. The code is executable on a processor. In other embodiments, all or a portion of the apparatus 200 is implemented using a programmable hardware device and/or hardware circuits.

The apparatus 200 includes a capture module 202 configured to capture, by an IR camera 110, a first set of images when an IR illuminator 112 is turned on and a second set of images when the IR illuminator 112 is turned off. In some embodiments, the IR illuminator 112 emits IR light when the IR illuminator is turned on. In some embodiments, the IR illuminator 112 does not emit IR light when the IR illuminator is turned off. In some embodiments, the set of images may be one or more video frames. In some embodiments, the capture module 202 may capture the sets of images based on a duty cycle of the IR camera 110. In some embodiments, the capture module 202 may capture the first set of images when the IR illuminator 112 is on, i.e., emitting IR light. In some embodiments, the capture module 202 may capture the second set of images when the IR illuminator 112 is off, i.e., not emitting IR light. Beneficially, capturing images when the IR illuminator 112 is on and when the IR illuminator 112 is off allows detection of an attacker because for a real human face, the exposure difference values will be relatively large between times when the IR illuminator 112 is on versus times when the IR illuminator 112 is off, but the exposure difference values will be relatively low for an attack system.

In other embodiments, the IR camera 110 may continuously capture a plurality of images and the capture module 202 may classify the plurality of images into the first set of images and the second set of images based on the status of the IR illuminator 112 (e.g., IR illuminator on or IR illuminator off). In some embodiments, the capture module 202 may add a tag to the first set of images which indicates that the first set of images were captured when the IR illuminator was on. In some embodiments, the capture module may add another tag to the second set of images which indicates that the second set of images were captured when the IR illuminator was off. In some embodiments, the capture module 202 is configured to turn on and turn off the IR illuminator 112 in accordance with a duty cycle of the IR illuminator 112.

The apparatus 200 includes an exposure module 204 configured to determine a set of exposure difference values between the first set of images and the second set of images. As used herein, a set of exposure difference values refers to a set of differences between one or more exposure values associated with the first set of images and one or more corresponding exposure values associated with the second set of images. In one example, the exposure of the first set of images is the average of the exposure values of the first set of images. In another example, the exposure of the first set of images may be the maximum (or minimum) exposure value of the exposure values of the first set of images. In one example, the exposure of the second set of images is the average of the exposure values of the second set of images. In another example, the exposure of the second set of images may be the maximum (or minimum) exposure value of the exposure values of the second set of images. In some embodiments, the exposure value associated with an image is measured based on the amount of IR radiation detected over a period at the IR camera 110. In some embodiments, the exposure module 204 is configured to calculate the differences between the exposure of the first set of images and the exposure of the second set of images to determine the exposure difference values.

The apparatus 200 includes an attack module 206 configured to identify an attack in response to the set of exposure difference values satisfying a first threshold. In some embodiments, the attack module 206 may identify an attack when the exposure difference values calculated by the exposure module 204 are greater than a threshold. For example, when the computing device 116 is facing a real human face, the exposure values are very low in 850nm or 940nm when the IR illuminator 112 is off. However, when the computing device 116 is facing an attack system (e.g., an LCD screen with the image of the human face) the exposure values are not very low in 850nm or 940nm when the IR illuminator 112 is off. In general, a real human face reflects IR light falling on the real human face, whereas for an LCD screen the emitted IR light will be significantly more than the reflected IR light falling on the LCD screen. Therefore, for a real human face, the exposure difference values will be relatively large between times when the IR illuminator 112 is on versus times when the IR illuminator 112 is off, but the exposure difference values will be relatively low for an attack system.

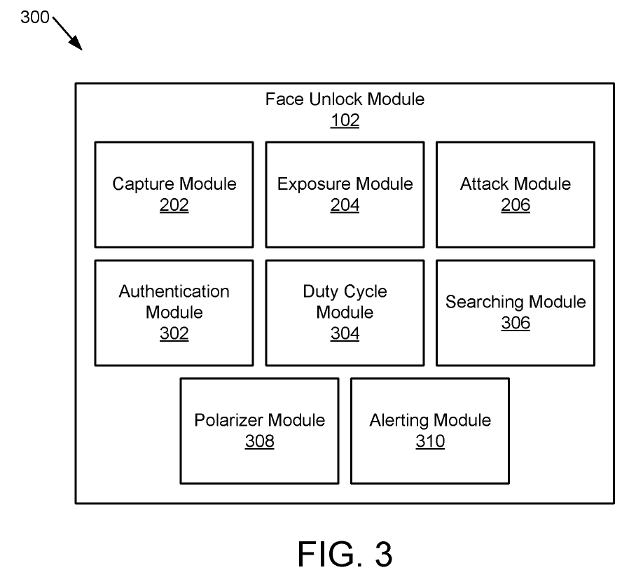

FIG. 3 is a schematic block diagram illustrating another apparatus 300 for detecting an attack on a facial authentication system, in accordance with aspects of the present disclosure. The apparatus 300 includes the face unlock module 102 that includes a capture module 202, an exposure module 204, and an attack module 206 which are substantially similar to those described above in relation to the apparatus 200 of FIG. 2. In the implementation shown in FIG. 3, the face unlock module 102 may additionally include, in various embodiments, one or more of: an authentication module 302, a duty cycle module 304, a searching module 306, a polarizer module 308, and an alerting module 310, or any combination thereof. In various embodiments, all or a portion of the apparatus 300 is implemented similar to the apparatus 200 of FIG. 2. In some embodiments, the apparatus 300 is implemented using executable code stored on a computer readable storage device, which is non-transitory. The code is executable on a processor. In other embodiments, all or a portion of the apparatus 300 is implemented using a programmable hardware device and/or hardware circuits.

In some embodiments, the apparatus 300 may include an authentication module 302 configured to perform a face authentication. In some embodiments, the authentication module 302 is configured to limit performing the face authentication to a period when the IR illuminator 112 is turned on. For example, the authentication module 302 may perform face authentication only when the IR illuminator 112 is turned on. Beneficially, since the IR illuminator 112 enables the computing device 116 to differentiate between a real human face and an image, video or a mask, performing the face authentication when the IR illuminator 112 is turned on reduces risks of unauthorized access to the computing device 116. In some embodiments, the authentication module 302 is configured to perform the face authentication in response to the set of exposure difference values not satisfying the first threshold. For example, the authentication module 302 is configured to perform the face authentication only when the attack module 206 determines that there is no attack on the computing device 116.

In some embodiments, the apparatus 300 may include a duty cycle module 304 configured to vary a duty cycle of the IR camera 110 and the IR illuminator 112. In some embodiments, the duty cycle may refer to the percentage of time a device is actively on compared to the time the device is off within a given period. For example, during a current period, the duty cycle of the IR camera 110 and the IR illuminator 112 may be 80% and 50% respectively, meaning that the IR camera 110 is on (i.e. capturing images) for 80% of the time and the IR illuminator 112 is on (i.e., emitting IR light) for 50% of the time. As another example, over the next period, the duty cycle of the IR camera 110 and the IR illuminator 112 may be changed to 70% and 40% respectively. By varying the duty cycle of the IR camera 110 and/or the IR illuminator 112, the duty cycle module 304 can prevent advanced spoofing by an attacker that modulates the backlight illumination of the attack system to mimic the IR illuminator 112 being turned on or off.

In some embodiments, the duty cycle may be varied in a random manner. Beneficially, varying the duty cycle of the IR camera 110 and the IR illuminator 112 in a random manner prevents the attacker from building an attack system that adjusts the IR light emitted by the attack system in such a way that it satisfies the threshold requirement of exposure difference values. For example, if the attacker can determine when the IR illuminator 112 is emitting IR light and/or not emitting the IR light and/or determine when the IR camera 110 is capturing and/or not capturing IR light, then the attacker may be able to build an attack system that adjusts (i.e., increase or decrease) the IR light emitted by the attack system based on when the IR illuminator is emitting IR light and/or not emitting the IR light and/or when the camera is capturing and/or not capturing. Therefore, varying the duty cycle in a random manner makes it difficult for an attacker to predict a current or a next duty cycle and build an attack system according to the current or the next duty cycle.

In some embodiments, the apparatus 300 may include a searching module 306 configured to search the first set of images for an illumination hotspot or a retro-reflection, or both. In general, a real human face does not produce an illumination hotspot or a retro-reflection. Therefore, the presence of an illumination hotspot or a retro-reflection indicates an attack from an attacker using an image for face authentication. For example, the glossy screen of an attack device may reflect IR light, such as ceiling lights, light from windows, etc., or light from the screen of the user device.

As used herein, an illumination hotspot refers to an uneven brightness on the screen where certain areas appear much brighter than others. In some embodiments, the searching module 306 is configured to search the first set of images for specular reflection from the attack device. As used herein, a retro-reflection refers to light reflecting to its source with minimal scattering. In some embodiments, the searching module 306 may employ a machine learning model to detect an illumination hotspot or a retro-reflection, or both. In some embodiments, attack module 206 is further configured to identify an attack in response to detecting the illumination hotspot or the retro-reflection, or both.

In some embodiments, the apparatus 300 may include a polarizer module 308 configured to adjust a polarization associated with inbound IR light captured at the IR camera 110. The inbound IR light refers to the IR light that is being received or detected by a sensor (e.g., IR camera). In general, a real human face will emit randomly polarized IR light while an LCD screen of an attack device (e.g., 502) emits polarized light. Since the LCD screen’s light is polarized, adjusting the polarization will cause significant intensity variations, making the image appear to fade in and out at certain angles.

In some embodiments, the polarizer 114 may include an optical filter that allows light waves of a specific polarization pass through while blocking light waves of other polarizations. In such embodiments, the polarizer module 308 may (e.g. mechanically) rotate a polarizer 114 in front of the IR camera 110 to adjust the polarization associated with inbound IR light captured at the IR camera 110. In some embodiments, the polarizer 114 may be configured to rotate in response to the IR camera 110 capturing a first image. In some embodiments the polarizer 114 may be configured to rotate by 90 degrees. In general, adjusting the polarizer 114 changes the angle of its polarization axis which directly affects how much polarized light is blocked or allowed through.

In other embodiments, the polarizer 114 may include a liquid crystal layer located in front of the IR camera 110, wherein the polarizer module 308 may adjust the polarization associated with inbound IR light captured at the IR camera 110, e.g. by applying an electric field. In general, a liquid crystal system is a state of matter between a liquid and a solid, where molecules have some degree of orientation. The liquid crystal system may be used to manipulate the polarization state of light by applying an electric field to change the alignment of the liquid crystal molecules allowing for dynamic control over how light is polarized within the system.

In some embodiments, the exposure module 204 is further configured to determine a first exposure value of a first image associated with a first polarization and a second exposure value of a second image associated with a second polarization. In some embodiments, the exposure module 204 determines the first exposure value of the first image associated with a first polarization in response to the IR camera 110 capturing the first image before the polarizer 114 is rotated. In some embodiments, the exposure module 204 determines the second exposure value of the second image associated with a second polarization in response to the IR camera 110 capturing the second image after the polarizer 114 is rotated. In some embodiments, the IR camera 110 captures the first image with the first polarization. In some embodiments, the IR camera 110 captures the second image with the second polarization.

The exposure module 204, in some embodiments, is configured to calculate a difference between the first exposure of the first image and the second exposure of the second image. In some embodiments, the exposure module 204 may use an IR sensor (not shown) to measure the first exposure of the first image and the second exposure of the second image. In some embodiments, the exposure of the first image and the second image is measured based on the amount of IR radiation detected over a period.

The attack module 206, in some embodiments, is further configured to identify the attack in response to a difference between the first exposure of a first image and the second exposure value of the second image satisfying a second threshold. In some embodiments, the attack module 206 may identify an attack when the difference between the first exposure of a first image and the second exposure value of the second image exceeds a second threshold. For example, if the exposure changes significantly on rotation of the polarizer 114, then the attack module 206 considers it an attack. In general, a real human face will emit randomly polarized IR light while an LCD screen of an attack device (e.g., 502) emits polarized light. Since the LCD screen’s light is naturally polarized, adjusting which polarization angles are captured by the IR camera 110 will cause significant intensity variations among images captured of an LCD screen, for example making the image of a user’s face appear to fade in and out at certain angles, thus revealing the presence of an attach vector.

In some embodiments, the apparatus 300 may include an alerting module 310 configured to alert a user in response to identifying the attack. In some embodiments, the alerting module 310 may alert (e.g. notify) the user and/or indicate the authentication module 302 to not perform face authentication in response to the set of exposure difference values satisfying a first threshold, detecting the illumination hotspot or the retro-reflection, or both, and/or a difference between the first exposure value of a first image associated with a first polarization and the second exposure value of a second image associated with a second polarization satisfying a second threshold.

In some embodiments, the user may be the user of the computing device. In other embodiments, the user may be an IT manager. In some embodiments, the alerting module 310 may send an alert message to the IT manager device 120. In some embodiments, the alerting module 310 may send an alert message to another electronic device (e.g., a smartphone) of the user.

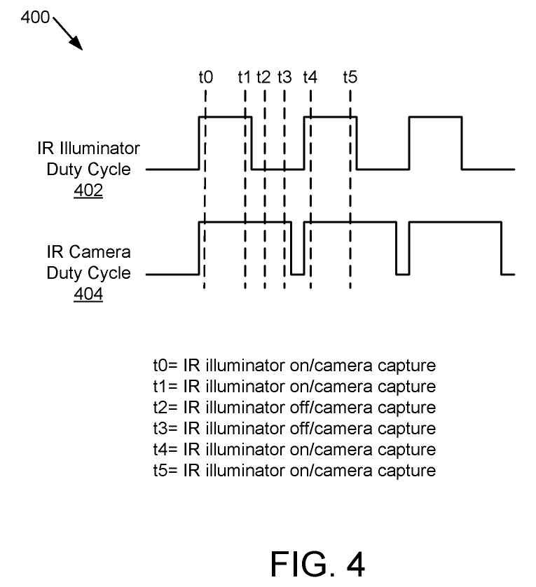

FIG. 4 is a timing diagram 400 illustrating duty cycle of an IR illuminator 112 and an IR camera 110, in accordance with aspects of the present disclosure. The timing diagram 400 may be implemented by aspects of the system 100. For example, the timing diagram 400 may be implemented by the IR illuminator 112 and an IR camera 110 under the control of the face unlock module 102, which may be an example of the apparatus 200 and/or the apparatus 300.

In some embodiments, the IR illuminator’s duty cycle 402 may be, for example, 50% and the IR camera’s duty cycle 404 may be, for example, 80%. At time t0 the IR illuminator 112 and the IR camera 110 are in the on state. At time t1 the IR illuminator 112 and the IR camera 110 are in the on state. At time t2 the IR illuminator 112 is in the off state and the IR camera 110 is in the on state. At time t3 the IR illuminator 112 is in the off state and the IR camera 110 is in the on state. At time t4 the IR illuminator 112 and the IR camera 110 are in the on state. At time t5 the IR illuminator 112 and the IR camera 110 are in the on state.

In various embodiments, the IR illuminator 112 may emit IR light and the IR camera 110 may capture the first set of images when the on phase of their duty cycles overlap, such as during times t0 and t1. In various embodiments, the IR camera 110 may capture the second set of images while the IR illuminator 112 does not emit IR light during times t2-t3. In various embodiments, the face unlock module captures multiple images during t0 to t1 and t2 to t3.

In various embodiments, the face unlock module 102 may determine during t0 to t3 a set of exposure difference values between the first set of images and the second set of images. If there is a real human face being captured by the IR camera 110, then there will be a large difference in the exposure values of the first set of images captured when the IR illuminator 112 is on, as compared to the exposure values of the second set of images captured when the IR illuminator 112 is off. In contrast, if an attack system with an IR LCD screen is being captured by the IR camera 110, then there will be a relatively small difference in the exposure values of the first set of images captured when the IR illuminator 112 is on, as compared to the exposure values of the second set of images captured when the IR illuminator 112 is off. In this way, the face unlock module 102 may identify during time t0 to t3 an attack in response to the set of exposure difference values satisfying (i.e. being less than) a first threshold.

In various embodiments, a face authentication may be performed during t4 to t5, i.e., when the IR illuminator 112 is turned on. In some embodiments, the IR camera 110 may capture a third set of images during t4 to t5 for face authentication. In some embodiments, the face authentication may be performed during t4 to t5 in response to the face unlock module 102 not identifying any threat. In some embodiments, face authentication may not be performed during t2-t3. In some embodiments, the duty cycle 402 of the IR illuminator 112 and the duty cycle 404 of the IR camera 110 may be varied.

FIG. 5 is a schematic block diagram illustrating a user device 504 under an attack, in accordance with aspects of the present disclosure. In some embodiments, an attacker may use an attack device 502 to attempt to unlock the user device 504. In some embodiments, the attack device 502 may be an electronic device with a display, for example, a smartphone, a tablet PC, a laptop, etc. The user device 504 may be implemented by aspects of the system 100. For example, the user device 504 may be implemented by the computing device 116 comprising an IR illuminator 112, an IR camera 110, and a face unlock module 102, which may be an example of the apparatus 200 and/or the apparatus 300.

When activated, the IR illuminator 112 may emit IR light towards the attack device 502. When activated, the IR camera 110 may capture the IR light reflected from the attack device 502. In some embodiments, the user device 504 captures, by the IR camera 110, a first set of images when the IR illuminator 112 is turned on and captures a second set of images when the IR illuminator 112 is turned off. As shown in FIG. 4, the user device 504 may capture, by the IR camera 110, the first set of images during t0 to t1, i.e., when the IR camera 110 and the IR illuminator 112 are in the on state. The user device 504 may capture the second set of images during t2 to t3, i.e., when the IR camera 110 is in the on state and the IR illuminator 112 is in the off state.

In some embodiments, the user device 504 searches the first set of images for an illumination hotspot 506 or a retro-reflection, or both. For example, the face unlock module 102 may search the first set of images that were captured during t0 to t1, for the illumination hotspot or the retro-reflection, or both. In some embodiments, the user device 504 identifies an attack from the attack device 502 in response to detecting the illumination hotspot 506 or the retro-reflection, or both.

If no hotspot or retro-reflection is detected, then in some embodiments, the user device 504 may determine a set of exposure difference values between the first set of images and the second set of images. In some embodiments, the user device 504 identifies an attack from the attack device 502 in response to the set of exposure difference values satisfying (i.e., being less than) a first threshold.

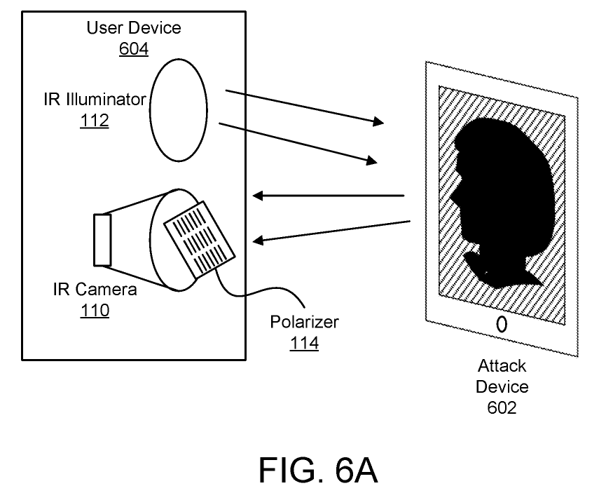

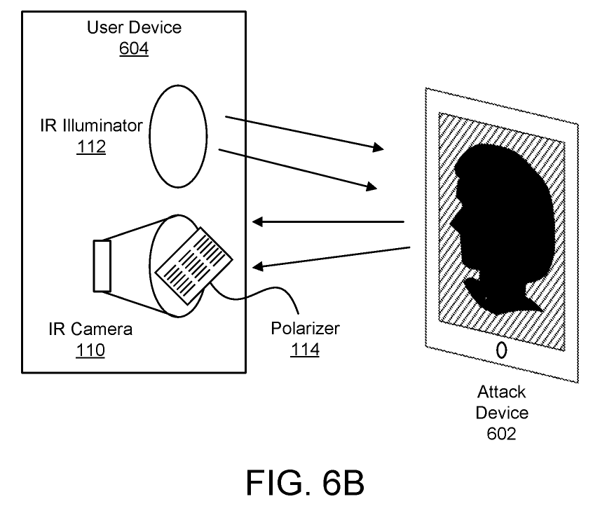

FIG. 6A is a block diagram illustrating the use of a polarizer 114 to detect a facial authentication attack, in accordance with aspects of the present disclosure. The user device 604 may be implemented by aspects of the system 100. For example, the user device 604 may be implemented by the computing device 116 comprising an IR illuminator 112, an IR camera 110, and a face unlock module 102, which may be an example of the apparatus 200 and/or the apparatus 300. In some embodiments, a polarizer 114 is placed in front of the IR camera 110 while capturing IR light, e.g., from the attack device 602 as shown in FIG. 6A. In some embodiments, the polarizer 114 is configured to be rotated mechanically about the IR camera 110. In one embodiment, the polarizer 114 may be rotated between a set of angles (e.g., 30 degrees, 60 degrees, 90 degrees, etc.). In another embodiment, the polarizer may rotate 360 degrees or more.

In some embodiments, the IR camera 110 captures a first image with a first polarization, i.e., before rotating the polarizer 114. In some embodiments, the user device 604 determines the first exposure value of the first image associated with the first polarization. In the depicted example, the polarizer 114 is depicted as an optical filter placed in front of a lens of the IR camera 110. However, in other embodiments, the polarizer 114 may be a liquid crystal system placed in front of the IR camera 110 to adjust the polarization associated with inbound IR light captured at the IR camera 110. The liquid crystal system may be used to manipulate the polarization state of light by applying an electric field to change the alignment of the liquid crystal molecules allowing for dynamic control over what polarization is detected at the IR camera 110.

FIG. 6B is a block diagram illustrating rotation of the polarizer 114 to detect a facial authentication attack, in accordance with aspects of the present disclosure. The user device 604 may be implemented by aspects of the system 100. For example, the user device 604 may be implemented by the computing device 116 comprising an IR illuminator 112, an IR camera 110, and a face unlock module 102, which may be an example of the apparatus 200 and/or the apparatus 300. In some embodiments, the user device 604 adjusts the polarization associated with inbound IR light captured at the IR camera 110 by rotating the polarizer 114 by at least a minimum angle. In one embodiment, the angle of rotation is a preset angle. In another embodiment, the angle of rotation is a random value selected between a preset minimum angle and a preset maximum angle. In some embodiments, the IR camera 110 captures a second image with a second polarization i.e., after rotating the polarizer 114. In some embodiments, the user device 604 determines the second exposure value of the second image associated with the second polarization and calculates a difference between the first exposure value and the second exposure value.

In some embodiments, the user device 604 identifies the attack in response to the difference between the first exposure value and the second exposure value satisfying a second threshold. In some embodiments, the user device 604 may identify an attack when the difference between the first exposure of a first image and the second exposure value of the second image exceeds a second threshold. For example, if the exposure changes significantly on rotation of the polarizer 114, then the user device 604 considers it an attack. In general, a real human face will emit randomly polarized IR light while an LCD screen of an attack device 602 emits a polarized light. Since the LCD screen’s light is naturally polarized, adjusting the polarization will cause significant intensity variations, making the image appear to fade in and out at certain angles.

In some embodiments, the face unlock module 102 may adjust polarization associated with inbound IR light captured at the IR camera, i.e. during t0 to t1 of the timeline of FIG. 4. In some embodiments, the face unlock module 102 may determine, e.g., during t0 to t1, a first exposure value of a first image associated with a first polarization and a second exposure value of a second image associated with a second polarization, where the first image and the second image are captured during t0 to t1.

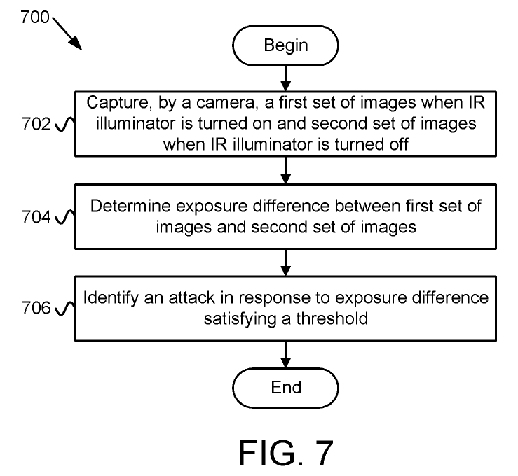

FIG. 7 is a schematic flow chart diagram illustrating a method 700 for detecting an attack on a facial authentication system, in accordance with aspects of the present disclosure. The method 700 may be implemented by aspects of the system 100. For example, the method 700 may be implemented by the IR illuminator 112 and an IR camera 110 under the control of the face unlock module 102, which may be an example of the apparatus 200 and/or the apparatus 300. The method 700 begins and captures 702, e.g., by an IR camera 110, a first set of images when an IR illuminator 112 is turned on and a second set of images when the IR illuminator 112 is turned off. The method 700 determines 704 a set of exposure difference values between the first set of images and the second set of images. The method 700 identifies 706 an attack in response to the set of exposure difference values satisfying a first threshold and the method 700 ends.

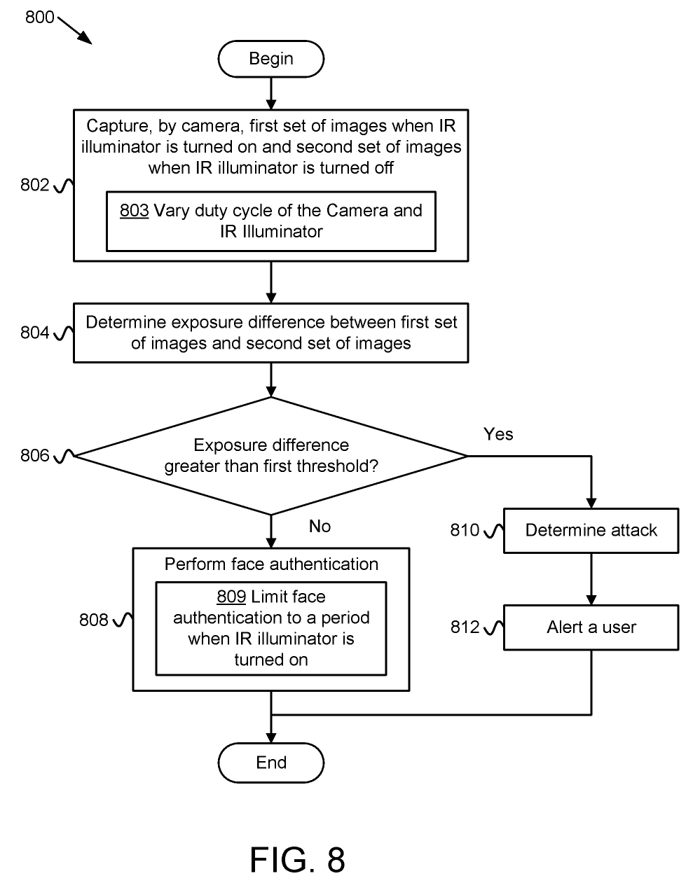

FIG. 8 is a schematic flow chart diagram illustrating another method 800 for detecting an attack on a facial authentication system, in accordance with aspects of the present disclosure. The method 800 may be implemented by aspects of the system 100. For example, the method 800 may be implemented by the IR illuminator 112 and an IR camera 110 under the control of the face unlock module 102, which may be an example of the apparatus 200 and/or the apparatus 300. The method 800 begins and captures 802, by an IR camera 110, a first set of images when an IR illuminator 112 is turned on and a second set of images when the IR illuminator 112 is turned off. The method 800 may vary 803 a duty cycle of the IR camera 110 and/or the IR illuminator 112. The method 800 determines 804 a set of exposure difference values between the first set of images and the second set of images.

The method 800 determines 806 whether any value of the set of exposure difference values is greater than a first threshold. If the set of exposure difference values are not greater than the first threshold, the method 800 performs 808 a face authentication and the method 800 ends. The method 800 may limit 809 performing face authentications to a period when the IR illuminator 112 is turned on. If the set of exposure difference values are greater than the first threshold, the method 800 determines 810 that an attack is occurring. The method 800 may alert 812 a user in response to identifying the attack and the method 800 ends.

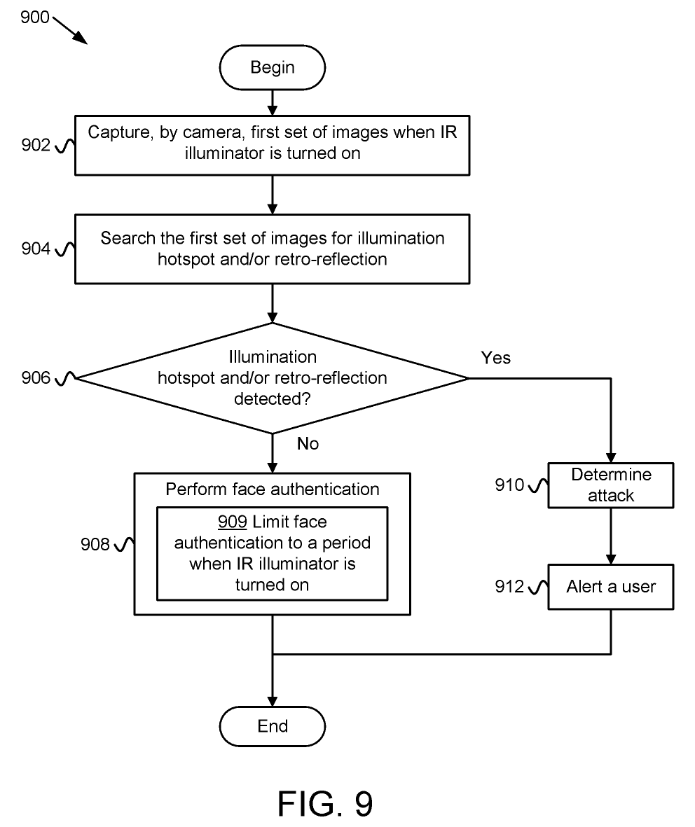

FIG. 9 is a schematic flow chart diagram illustrating another method 900 for detecting an attack on a facial authentication system, in accordance with aspects of the present disclosure. The method 900 may be implemented by aspects of the system 100. For example, the method 900 may be implemented by the IR illuminator 112 and an IR camera 110 under the control of the face unlock module 102, which may be an example of the apparatus 200 and/or the apparatus 300. The method 900 begins and captures 902 by an IR camera 110, a first set of images when an IR illuminator 112 is turned on. The method 900 searches 904 the first set of images for an illumination hotspot or a retro-reflection, or both.

The method 900 determines 906 whether there is an illumination hotspot and/or a retro-reflection detected. If an illumination hotspot and/or a retro-reflection is not detected the method 900 performs 908 a face authentication and the method 900 ends. The method 900 limits 909 face authentication to a period when the IR illuminator 112 is turned on. If an illumination hotspot and/or a retro-reflection is detected the method 900 determines 910 that an attack is occurring. The method 900 may alert 912 a user in response to determining that the attack is occurring and the method 900 ends.

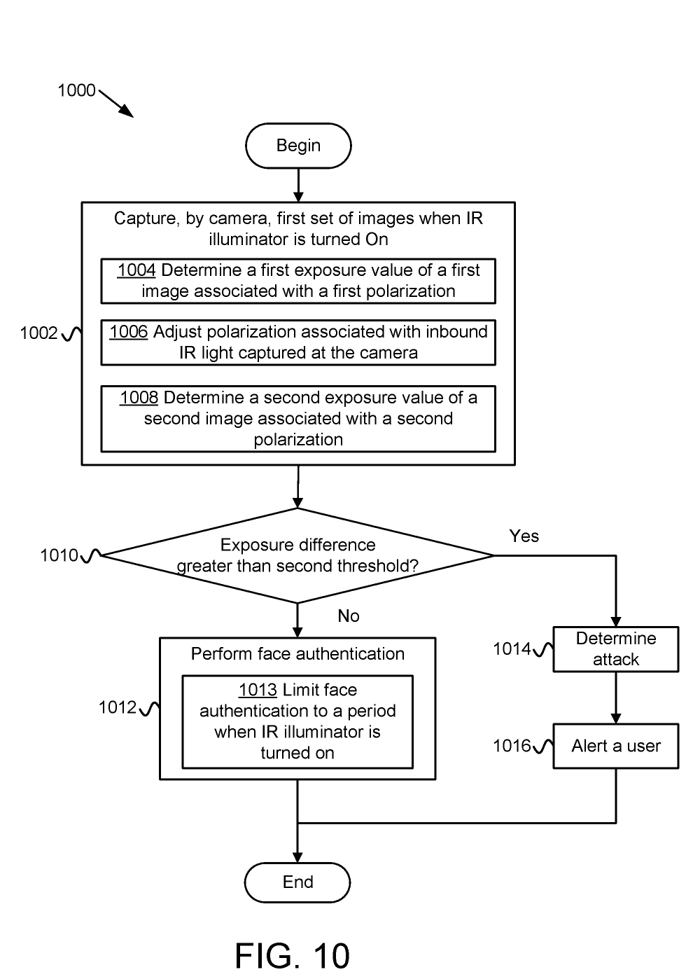

FIG. 10 is a schematic flow chart diagram illustrating another method 1000 for detecting an attack on a facial authentication system, in accordance with aspects of the present disclosure. The method 1000 may be implemented by aspects of the system 100. For example, the method 1000 may be implemented by the IR illuminator 112 and an IR camera 110 under the control of the face unlock module 102, which may be an example of the apparatus 200 and/or the apparatus 300. The method 1000 begins and captures 1002 by an IR camera 110, a first set of images when an IR illuminator 112 is turned on. In the depicted embodiment, capturing 1002 the first set of images includes the following:

The method 1000 determines 1004 a first exposure value of a first image associated with a first polarization. The method 1000 adjusts 1006 a polarization associated with inbound IR light captured at the IR camera 110. The method 1000 determines 1008 a second exposure value of a second image associated with a second polarization.

After capturing 1002 the first set of images, the method 1000 determines 1010 whether a difference between the first exposure value and the second exposure value is greater than a threshold which is different from the threshold used to compare the first set of images captured when the IR illuminator 112 is turned on with the second set of images when the IR illuminator 112 is turned off. If the difference between the first exposure value and the second exposure value is not greater than a second threshold, the method 1000 performs 1012 a face authentication and the method 1000 ends. The method 1000 limits 1013 face authentication to a period when the IR illuminator 112 is turned on. If the difference between the first exposure value and the second exposure value is greater than a second threshold, the method 1000 determines 1014 that an attack is occurring. The method 1000 may alert 1016 a user in response to determining that the attack is occurring and the method 1000 ends.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
capturing, by an infrared (“IR”) camera, a first set of images when an IR illuminator is turned on and a second set of images when the IR illuminator is turned off;
determining a set of exposure difference values between the first set of images and the second set of images; and
identifying an attack in response to the set of exposure difference values satisfying a first threshold.

2. The method of claim 1, further comprising performing a face authentication, wherein performing the face authentication is limited to a period when the IR illuminator is turned on.

3. The method of claim 2, further comprising performing the face authentication in response to the set of exposure difference values not satisfying the first threshold.

4. The method of claim 1, further comprising varying a duty cycle of the IR camera and the IR illuminator.

5. The method of claim 1, further comprising:
searching the first set of images for an illumination hotspot or a retro-reflection, or both; and
identifying the attack in response to detecting the illumination hotspot or the retro-reflection, or both.

6. The method of claim 1, further comprising:
adjusting a polarization associated with inbound IR light captured at the IR camera;
determining a first exposure value of a first image associated with a first polarization;
determining a second exposure value of a second image associated with a second polarization; and
identifying the attack in response to a difference between the first exposure value and the second exposure value satisfying a second threshold.

7. The method of claim 1, further comprising alerting a user in response to identifying the attack.

8. An apparatus comprising:
a processor; and
a non-transitory computer readable storage medium storing code, the code being executable by the processor to perform operations comprising:
capturing, by an infrared (“IR”) camera, a first set of images when an IR illuminator is turned on and a second set of images when the IR illuminator is turned off;
determining a set of exposure difference values between the first set of images and the second set of images; and
identifying an attack in response to the set of exposure difference values satisfying a first threshold.

9. The apparatus of claim 8, wherein the operations further comprise performing a face authentication, wherein performing the face authentication is limited to a period when the IR illuminator is turned on.

10. The apparatus of claim 9, wherein the operations further comprise performing the face authentication in response to the set of exposure difference values not satisfying the first threshold.

11. The apparatus of claim 8, wherein the operations further comprise varying a duty cycle of the IR camera and the IR illuminator.

12. The apparatus of claim 8, wherein the operations further comprise:
searching the first set of images for an illumination hotspot or a retro-reflection, or both; and
identifying the attack in response to detecting the illumination hotspot or the retro-reflection, or both.

13. The apparatus of claim 8, wherein the operations further comprise:
adjusting a polarization associated with inbound IR light captured at the IR camera;
determining a first exposure value of a first image associated with a first polarization;
determining a second exposure value of a second image associated with a second polarization; and
identifying the attack in response to a difference between the first exposure value and the second exposure value satisfying a second threshold.

14. The apparatus of claim 8, wherein the operations further comprise alerting a user in response to identifying the attack.

15. A program product comprising a non-transitory computer readable storage medium storing code, the code being configured to be executable by a processor to perform operations comprising:
capturing, by an infrared (“IR”) camera, a first set of images when an IR illuminator is turned on and a second set of images when the IR illuminator is turned off;
determining a set of exposure difference values between the first set of images and the second set of images; and
identifying an attack in response to the set of exposure difference values satisfying a first threshold.

16. The program product of claim 15, further comprises additional code configured to be executable by the processor to perform operations comprising performing a face authentication, wherein performing the face authentication is limited to a period when the IR illuminator is turned on.

17. The program product of claim 15, further comprises additional code configured to be executable by the processor to perform operations comprising varying a duty cycle of the IR camera and the IR illuminator.

18. The program product of claim 15, further comprises additional code configured to be executable by the processor to perform operations comprising:
searching the first set of images for an illumination hotspot or a retro-reflection, or both; and
identifying the attack in response to detecting the illumination hotspot or the retro-reflection, or both.

19. The program product of claim 15, further comprises additional code configured to be executable by the processor to perform operations comprising:
adjusting a polarization associated with inbound IR light captured at the IR camera;
determining a first exposure value of a first image associated with a first polarization;
determining a second exposure value of a second image associated with a second polarization; and
identifying the attack in response to a difference between the first exposure value and the second exposure value satisfying a second threshold.

20. The program product of claim 15, further comprises additional code configured to be executable by the processor to perform operations comprising alerting a user in response to identifying the attack.
